(19) United States
(12) Patent Application Publication
(10) Pub. No.: US 2007/0287066 A1
(43) Pub. Date: Dec. 13, 2007

(54) Alkaline primary battery

(76) Inventors: Tadaya Okada, Osaka (JP); Shigeto Noya, Osaka (JP); Isao Abe, Ehime (JP); Minoru Shiraoka, Ehime (JP)

Correspondence Address: MCDERMOTT WILL & EMERY LLP, 600 13TH STREET, NW, WASHINGTON, DC, 20005-3096, US

(21) Appl. No.: 11/808,159

(22) Filed: Jun. 7, 2007

Related U.S. Application Data
(60) Provisional application No. 60/814,908, filed on Jun. 20, 2006.

(30) Foreign Application Priority Data
Jun. 7, 2006 (JP) 2006-158708

(51) Int. Cl. H01M 4/52

(52) U.S. Cl. 429/223

(57) ABSTRACT

An alkaline primary battery includes a positive electrode containing at least nickel oxyhydroxide as a positive electrode active material, a negative electrode containing zinc or a zinc alloy as a negative electrode active material, a separator arranged between the positive electrode and the negative electrode, and an alkaline electrolyte. The nickel oxyhydroxide contains at least manganese and calcium as elements forming solid solution or eutectic crystal with the nickel oxyhydroxide.

### CLAIM OF PRIORITY

This application claims the benefit of Japanese Patent Application No. JP 2006-158708, filed on Jun. 7, 2006 and US Provisional Application No. 60/814,908, filed on Jun. 20, 2006, the disclosures of which are incorporated herein by reference.

### FIELD OF THE INVENTION

The present invention relates to an alkaline primary battery which contains at least nickel oxyhydroxide as a positive electrode active material.

### BACKGROUND OF THE INVENTION

Generally, an alkaline primary battery has an inside-out structure in which a cylindrical positive electrode mixture is arranged in a positive electrode case serving as a positive electrode terminal in close contact with the inner surface of the positive electrode case, and a gel negative electrode is arranged in the center of the positive electrode mixture via a separator. In recent years, with the popularization of digital apparatuses, the load power of the apparatus is continuously increasing, and there is an increasing demand for improvement in the heavy load discharge performance of a battery used as a power source for the apparatus.

For example, there is proposed in Japanese Laid-Open Patent Publication No. 2000-48827 an alkaline primary battery in which nickel oxyhydroxide is used for a positive electrode active material in order to improve the heavy load discharge performance.

However, in the alkaline primary battery in which nickel oxyhydroxide is used for the positive electrode active material, the heavy load discharge performance after high temperature storage may be more deteriorated as compared with an alkaline primary battery in which manganese dioxide is used for the positive electrode active material, due to an increase in the resistance between the positive electrode case and the positive electrode mixture, a decrease in the amount of the positive electrode active material contributing to the discharge, or the like. On the other hand, it is proposed in Japanese Laid-Open Patent Publication No. 2004-259453 to use nickel oxyhydroxide made eutectic with manganese for the positive electrode active material, in order to suppress the deterioration of the heavy load discharge performance after high temperature storage.

The alkaline primary battery in which nickel oxyhydroxide is used for the positive electrode active material, has excellent heavy load discharge performance as compared with the alkaline primary battery in which manganese dioxide is used for the positive electrode active material, and hence is spreading as a main power supply of a digital apparatus represented by a digital camera. For example, in the digital camera, it is necessary to instantaneously supply heavy load power depending on various functions, such as those for emitting strobe light, moving an optical lens in and out, display on a liquid crystal part, and writing image data to a recording medium.

However, in the conventional alkaline primary battery in which nickel oxyhydroxide is used for the positive electrode active material, nickel hydroxide generated by the discharge is an insulator, and hence it is difficult to instantaneously supply the heavy load power when the discharge progresses, as a result of which the power supply of the digital camera may be suddenly interrupted. That is, in the alkaline primary battery in which nickel oxyhydroxide is used for the positive electrode active material, polarization in the final stage of the heavy load pulse discharge is large as compared with the alkaline primary battery in which manganese dioxide is used for the positive electrode active material, which may cause sudden battery exhaustion.

Particularly, in the alkaline primary battery disclosed in Japanese Laid-Open Patent Publication No. 2004-259453 in which nickel oxyhydroxide is made eutectic with manganese in order to improve the heavy load discharge performance of the battery after high temperature storage, polarization in the final stage of the heavy load discharge is increased to easily cause sudden battery exhaustion.

In order to solve the above described problems, it is an object of the invention to provide an alkaline primary battery having excellent high temperature storage performance, and at the same time, having excellent heavy load pulse discharge performance, in which the sudden voltage drop is prevented by suppressing the increase in polarization in the final stage of the discharge.

### BRIEF SUMMARY OF THE INVENTION

An alkaline primary battery according to the present invention, including: a positive electrode containing at least nickel oxyhydroxide as a positive electrode active material; a negative electrode containing zinc or a zinc alloy as a negative electrode active material; a separator arranged between the positive electrode and the negative electrode; and an alkaline electrolyte, is characterized in that the nickel oxyhydroxide contains at least manganese and calcium as elements forming solid solution or eutectic crystal with the nickel oxyhydroxide.

Preferably, the nickel oxyhydroxide contains manganese in an amount of 2.0×10⁻² to 10.0×10⁻² mol per mol of nickel oxyhydroxide, and calcium in an amount of 0.2×10⁻² to 5.0×10⁻² mol per mol of nickel oxyhydroxide.

More preferably, the nickel oxyhydroxide contains manganese in an amount of 2.0×10⁻² to 5.0×10⁻² mol per mol of nickel oxyhydroxide, and calcium in an amount of 2×10⁻² to 5.0×10⁻² mol per mol of nickel oxyhydroxide.

According to the present invention, it is possible to obtain an alkaline primary battery having excellent high temperature storage performance, and at the same time, having excellent heavy load pulse discharge performance, in which the sudden voltage drop in the final stage of discharge is prevented by suppressing the increase in polarization in the final stage of discharge.

While the novel features of the invention are set forth particularly in the appended claims, the invention, both as to organization and content, will be better understood and appreciated, along with other objects and features thereof, from the following detailed description taken in conjunction with the drawings.

### BRIEF DESCRIPTION OF THE SEVERAL VIEWS OF THE DRAWING

FIG. 1 is a front view showing partly in section an alkaline dry battery according to the present invention; and

FIG. 2 is an example of an X-ray diffraction pattern of a nickel hydroxide powder.

### DETAILED DESCRIPTION OF THE INVENTION

The present inventors optimized elements to be contained in nickel oxyhydroxide and the content of the elements in order to obtain an alkaline primary battery suitable for the characteristics of a digital apparatus having a large load power, as typified by a digital camera. As a result, the present inventors have found that an alkaline primary battery in which nickel oxyhydroxide forming solid solution or eutectic crystal with manganese and calcium is used for a positive electrode active material, exhibits excellent heavy load pulse discharge performance in an initial stage or after storage.

That is, the present invention relates to an alkaline primary battery including: a positive electrode containing at least nickel oxyhydroxide as a positive electrode active material; a negative electrode containing zinc or a zinc alloy as a negative electrode active material; a separator arranged between the positive electrode and the negative electrode; and an alkaline electrolyte, characterized in that the nickel oxyhydroxide contains at least manganese and calcium as elements forming solid solution or eutectic crystal with the nickel oxyhydroxide.

By using the nickel oxyhydroxide made to form solid solution or eutectic crystal with manganese for the positive electrode active material, oxygen generating potential of the positive electrode is increased, and high temperature storage performance is improved. In addition, when the nickel oxyhydroxide containing manganese is further made to form solid solution or eutectic crystal with calcium, a distortion is caused in the crystal lattice of the nickel oxyhydroxide, and the diffusion of protons in the crystal is promoted. It was found that this enables polarization in the final stage of discharge to be reduced at the time of heavy load pulse discharge, so as to suppress the sudden voltage drop in the final stage of the discharge.

Preferably, the content of manganese in nickel oxyhydroxide is set in a range from 2.0×10⁻² to 10.0×10⁻² mol per mol of nickel oxyhydroxide. When the content of manganese in nickel oxyhydroxide is set to be less than 2.0×10⁻² mol per mol of nickel oxyhydroxide, the storage performance cannot be sufficiently improved. On the other hand, when the content of manganese in nickel oxyhydroxide exceeds 10.0×10⁻² mol per mol of nickel oxyhydroxide, the content of nickel is decreased and the capacity of the battery is reduced.

More preferably, the content of manganese in nickel oxyhydroxide is set in a range from 2.0×10⁻² to 5.0×10⁻² mol per mol of nickel oxyhydroxide.

Preferably, the content of calcium in nickel oxyhydroxide is set in a range from 0.2×10⁻² to 5.0×10⁻² mol per mol of nickel oxyhydroxide. When the content of calcium in nickel oxyhydroxide is set to be less than 0.2×10⁻² mol per mol of nickel oxyhydroxide, the heavy load pulse discharge performance and the storage performance cannot be sufficiently improved. On the other hand, when the content of calcium in nickel oxyhydroxide exceeds 5.0×10⁻² mol per mol of nickel oxyhydroxide, the content of nickel is decreased and the capacity of the battery is reduced.

More preferably, the content of calcium in nickel oxyhydroxide is set in a range from 2.0×10⁻² to 5.0×10⁻² mol per mol of nickel oxyhydroxide.

In addition to manganese and calcium, cobalt may be further made to form solid solution or eutectic crystal with nickel oxyhydroxide. The electron conductivity is improved and the polarization at the time of discharge is reduced, so that the discharge performance can be further improved.

Preferably, the content of cobalt in nickel oxyhydroxide is set in a range from 0.5×10⁻² to 2.0×10⁻² mol per mol of nickel oxyhydroxide. When the content of cobalt in nickel oxyhydroxide is set to be less than 0.5×10⁻² mol per mol of nickel oxyhydroxide, the effect of improving electron conductivity is small. On the other hand, when the content of cobalt in nickel oxyhydroxide exceeds 2.0×10⁻² mol per mol of nickel oxyhydroxide, the content of nickel is decreased and the capacity of the battery is reduced.

For the positive electrode, there is used, for example, a positive electrode mixture made of a mixture of at least the above described nickel oxyhydroxide powder as a positive electrode active material, a graphite powder as a conductive material, and an alkaline electrolyte.

A mixture of the nickel oxyhydroxide powder and a manganese dioxide powder may also be used for the positive electrode active material.

As for volume-based average particle diameters of the nickel oxyhydroxide powder and the manganese dioxide powder, for example, the average particle diameter of the nickel oxyhydroxide is set in a range from 8 to 20 μm, and the average particle diameter of the manganese dioxide powder is set in a range from 30 to 50 μm.

A volume-based average particle diameter of the graphite powder is set, for example, in a range from 8 to 25 μm.

Further, the volume-based average particle diameter of the nickel oxyhydroxide powder is preferably set in a range from 8 to 18 μm. In this case, the filling property of the positive electrode mixture is improved and its contact state with the graphite powder serving as the conductive material is made excellent, as a result of which the heavy load discharge performance in an initial stage and after high temperature storage is improved. When the volume-based average particle diameter of the nickel oxyhydroxide powder is smaller than 8 μm, the filling property of the positive electrode mixture is significantly deteriorated. When the volume-based average particle diameter of the nickel oxyhydroxide powder exceeds 18 μm, its contact nature with the graphite powder serving as the conductive material is deteriorated.

Preferably, the average nickel valence of the nickel oxyhydroxide powder is set to 2.95 or more. In this case, the ratio of nickel hydroxide in the positive electrode active material powder is decreased, so that the heavy load discharge performance in an initial stage and after high temperature storage is improved.

Preferably, the nickel oxyhydroxide powder and the manganese dioxide powder in the positive electrode are mixed in the weight ratio of 20:80 to 90:10. In this case, the heavy load pulse discharge performance is improved, and a sufficient effect of suppressing the temperature rise upon occurrence of battery short-circuit can be obtained. When the content of the nickel oxyhydroxide powder in the positive electrode is less than 20 parts by weight per 100 parts by weight of the total of the nickel oxyhydroxide powder and the manganese dioxide powder, the effect of improving the heavy load discharge performance by adding nickel oxyhydroxide cannot be sufficiently obtained. When the content of the nickel oxyhydroxide powder in the positive electrode exceeds 90 parts by weight per 100 parts by weight of the total of the nickel oxyhydroxide powder and the manganese dioxide powder, the capacity of the battery is reduced.

For the negative electrode, there is used, for example, a gel negative electrode made of a mixture of a zinc powder or a zinc alloy powder as a negative electrode active material, sodium polyacrylate as a gelling agent, and an alkaline electrolyte. The zinc alloy contains, for example, aluminum, bismuth, and indium.

The zinc powder or the zinc alloy powder contains, for example, 60 to 80% by weight of a powder whose particle diameter is larger than 75 μm and not larger than 425 μm, and to 40% by weight of a powder whose particle diameter is not larger than 75 μm.

For the separator, for example, a nonwoven fabric formed by mainly mixing and weaving polyvinyl alcohol fiber with rayon fiber is used.

For alkaline electrolyte, for example, a potassium hydroxide aqueous solution and a sodium hydroxide aqueous solution are used.

In the following, examples according to the present invention will be described, but the present invention is not limited to these examples.

### EXAMPLE 1

### (1) Production of Nickel Hydroxide Powder

A nickel sulfate aqueous solution of 2.55 mol/L, a manganese sulfate aqueous solution of 0.08 mol/L, a calcium chloride aqueous solution of 0.05 mol/L, a sodium hydroxide aqueous solution of 5 mol/L, and an ammonia aqueous solution of 5 mol/L were prepared. The respective aqueous solutions were continuously fed at a flow rate of 0.5 ml/min into a reaction apparatus provided with a stirring blade and held at 40° C. Subsequently, pH became constant, and the balance between metallic salt concentration and metal hydroxide particle concentration was fixed, so that a stable state was established in the reaction apparatus. In this state, a suspension obtained by overflow was collected, and a precipitate was separated by decantation. The precipitate was processed by a sodium hydroxide aqueous solution at pH 13 to 14, to remove anions such as sulfate ions in metal hydroxide particles, and thereafter washed with water and dried. In this way, a nickel hydroxide powder having a volume-based average particle diameter of 12.4 μm was obtained. Note that for the measurement of the volume-based average particle diameter, a laser diffraction type particle size distribution meter (particle size distribution measuring instrument “Microtrack FRA” manufactured by Nikkiso Co., Ltd.) was used.

The crystal structure of the nickel hydroxide particles obtained as described above was measured by the powder X-ray diffraction method as will be described below. Here, a typical X-ray diffraction pattern of the nickel hydroxide powder is shown in FIG. 2.

The powder X-ray diffraction apparatus “RINT1400” manufactured by Rigaku Co., Ltd. was used for the measurement. The measuring condition was so set that anticathode: Cu, filter: nickel, tube voltage: 40 kV, tube current: 100 mA, sampling angle: 0.02 deg., scanning rate: 3.0 deg./min., divergent slit: ½ deg., and scattering slit: ½ deg.

From the X-ray diffraction pattern obtained by the above described X-ray diffraction measurement based on CuKα-ray, it was confirmed that the nickel hydroxide particles are formed into a single phase of β-Ni(OH)₂, and manganese and calcium added to the nickel hydroxide exist in the nickel hydroxide crystal in the state where nickel hydroxide is made to form solid solution or eutectic crystal with manganese and calcium. The amounts of manganese and calcium contained in the nickel hydroxide were set to 3.0×10⁻² and 2.0×10⁻² mol per mol of nickel oxyhydroxide as will be described below, respectively.

### (2) Production of Nickel Oxyhydroxide Powder

Next, in a chemical oxidation treatment of the nickel hydroxide powder obtained as described above, the nickel hydroxide powder was put into a sodium hydroxide aqueous solution of 0.5 mol/L, and a sodium hypochlorite aqueous solution (effective chlorine concentration: 12% by weight) was added to the resultant solution in an amount of 1.2 of oxidizing agent equivalent weight. Then, the obtained solution was stirred at the reaction atmosphere temperature of 45° C. for three hours, so that a nickel oxyhydroxide powder having a volume-based average particle diameter of 12 μm was produced. The obtained nickel oxyhydroxide powder was sufficiently washed with water and thereafter dried in vacuum at 60° C., so that a positive electrode active material powder was obtained.

### (3) Production of Positive Electrode Mixture

An alkaline electrolyte was obtained by mixing the nickel oxyhydroxide powder obtained as described above, a manganese dioxide powder having a volume-based average particle diameter of 35 μm, a graphite powder having a volume-based average particle diameter of 15 μm, and a potassium hydroxide aqueous solution of 37% by weight in the weight ratio of 50:50:6.5:1. The resultant mixture was uniformly stirred and mixed by a mixer, and processed to have a uniform particle size. The obtained particulate material was pressured and formed into a hollow cylindrical shape so that a positive electrode mixture was obtained.

### (4) Production of Alkaline Primary Battery

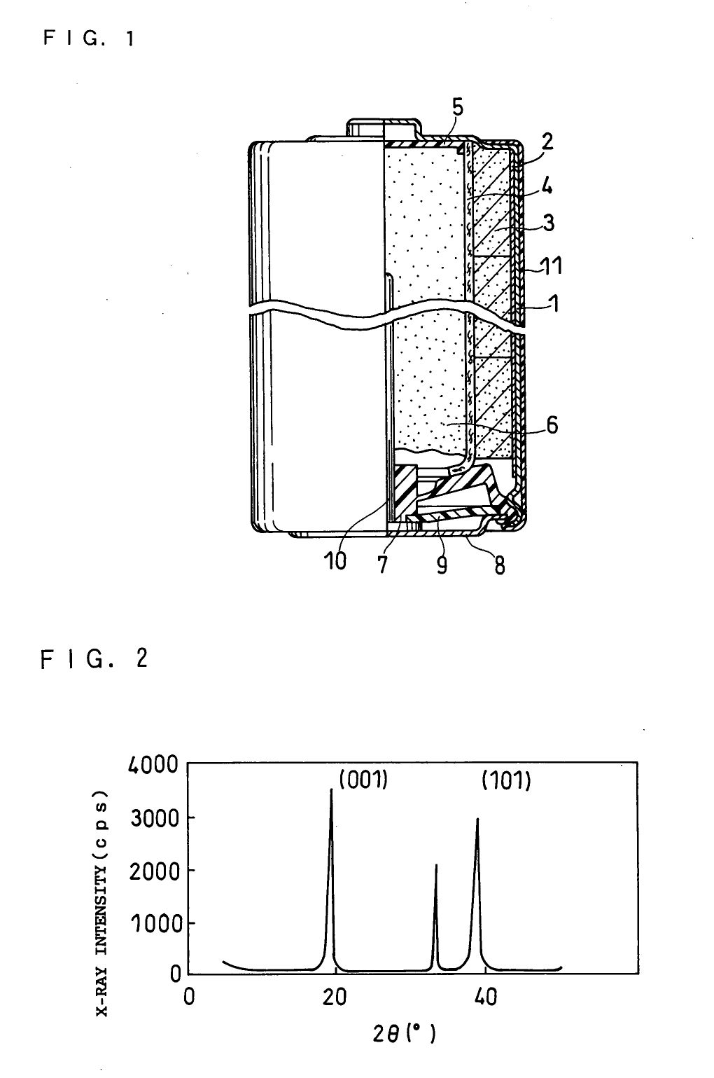

By using the positive electrode mixture obtained as described above, an AA size alkaline primary battery shown in FIG. 1 was produced as follows. FIG. 1 is a front view showing partly in section the alkaline primary battery according to an example of the present invention.

A plurality of positive electrode mixtures 3 were inserted in a bottomed cylindrical positive electrode case 1 made of a nickel plated steel sheet, on the inner surface of which case a graphite coating film 2 was formed. Then, the positive electrode mixtures 3 were brought into tight contact with the inner surface of the positive electrode case 1 by re-pressurizing the positive electrode mixtures 3 in the positive electrode case 1. Then, a separator 4 and an insulation cap 5 were arranged inside the positive electrode mixture 3, and thereafter a potassium hydroxide aqueous solution of 37% by weight as an electrolyte was supplied in order to wet the separator 4 and the positive electrode mixtures 3.

After the potassium hydroxide aqueous solution was supplied, a gel negative electrode 6 was filled inside the separator 4. For the gel negative electrode 6, a mixture obtained by mixing sodium polyacrylate as a gelling agent, a potassium hydroxide aqueous solution of 40% by weight as an alkaline electrolyte, and a negative electrode active material in the weight ratio of 1:33:66 was used. For the negative electrode active material, a zinc alloy containing 250 ppm Bi, 250 ppm In, and 35 ppm Al was used.

A negative electrode current collector 10 integrated with a resin sealing plate 7, a bottom plate 8 serving as a negative electrode terminal, and an insulation washer 9, was inserted into the gel negative electrode 6. The opening of the positive electrode case 1 was sealed by crimping the edge of the opening of the positive electrode case 1 onto the periphery of the bottom plate 7 with the end of the sealing plate 7 therebetween. The outer surface of the positive electrode case 1 was covered with an outer label 11. In this way, the alkaline primary battery 1 was produced.

### COMPARATIVE EXAMPLE 1

An alkaline primary battery 2 was produced in the same manner as in EXAMPLE 1, except that at the time of producing the nickel hydroxide powder, a nickel sulfate aqueous solution of 2.63 mol/L and a calcium chloride aqueous solution of 0.05 mol/L were used instead of the nickel sulfate aqueous solution of 2.55 mol/L, the manganese sulfate aqueous solution of 0.08 mol/L, and the calcium chloride aqueous solution of 0.05 mol/L.

### COMPARATIVE EXAMPLE 2

An alkaline primary battery 3 was produced in the same manner as in EXAMPLE 1, except that at the time of producing the nickel hydroxide powder, a nickel sulfate aqueous solution of 2.60 mol/L, and a manganese sulfate aqueous solution of 0.08 mol/L were used instead of the nickel sulfate aqueous solution of 2.55 mol/L, the manganese sulfate aqueous solution of 0.08 mol/L, and the calcium chloride aqueous solution of 0.05 mol/L.

### COMPARATIVE EXAMPLE 3

An alkaline primary battery 4 was produced in the same manner as in EXAMPLE 1, except that at the time of producing the nickel hydroxide powder, a nickel sulfate aqueous solution of 2.68 mol/L was used instead of the nickel sulfate aqueous solution of 2.55 mol/L, the manganese sulfate aqueous solution of 0.08 mol/L, and the calcium chloride aqueous solution of 0.05 mol/L.

The discharge test was performed in the environment of 20° C. for the respective batteries produced as described above and in an initial stage. Further, the same discharge test as in the initial stage was performed after the respective batteries were stored in the environment of 60° C. for two weeks.

In the discharge test, on the basis of the assumption that the battery is used as a power source of a digital camera, pulse discharge in which a step of discharging at 1.5 W for 2 seconds and a subsequent step of discharging at 0.65 W for 28 seconds were repeated 10 times, was performed for every hour. Then, the discharging duration time required for the closed circuit voltage of the battery to reach 1.05 V, and the width of the voltage drop (hereinafter expressed as ΔV) of the battery when the closed circuit voltage of the battery reached 1.05 V were measured.

Note that the ΔV is a difference between a closed circuit voltage, at the end of the 0.65 W discharge (the 28th second) just before the 1.5 W discharge for making the closed circuit voltage reach 1.05 V, and 1.05 V. The 1.5 W discharge causes the voltage drop to occur earlier than the 0.65 W discharge, and hence the closed circuit voltage surely reaches 1.05 V at the time of the 1.5 W discharge.

The results of the discharge test are shown in Table 1. The values of the pulse discharge performance in Table 1 are expressed by the index obtained by setting the discharging duration time of the battery 4 of COMPARATIVE EXAMPLE 3 to 100. The number of each battery used for the test was ten, and the discharging duration time in Table 1 is the average value of the discharging duration time for ten batteries.

TABLE 1

| | | | | Pulse discharge | | |
|---|---|---|---|---|---|---|
| | | | | | | After two |
| | | Content of each | | | | week |
| | | element in nickel | | In initial stage | | storage |
| | Bat- | oxyhydroxide | | Discharge | ΔV | Discharge |
| | tery | (×10⁻² mol) | | performance | value | performance |
| | No. | Manganese | Calcium | (index) | (mV) | (index) |
| Ex. 1 | 1 | 3 | 2 | 121 | 290 | 121 |
| Com. | 2 | 0 | 2 | 123 | 290 | 110 |
| Ex. 1 | | | | | | |
| Com. | 3 | 3 | 0 | 95 | 330 | 110 |
| Ex. 2 | | | | | | |
| Com. | 4 | 0 | 0 | 100 | 325 | 100 |
| Ex. 3 | | | | | | |

From Table 1, it was found that the alkaline primary battery 1 of EXAMPLE 1 in which the nickel oxyhydroxide contains both manganese and calcium, exhibits excellent discharge performance both in the initial stage and after storage, and has a smaller value of ΔV, as compared with the alkaline primary batteries 2 to 4 of COMPARATIVE EXAMPLEs 1 to 3.

In the alkaline primary battery 2 of COMPARATIVE EXAMPLE 1 using the nickel oxyhydroxide containing only calcium, the storage performance was insufficient. In the alkaline primary battery 3 of COMPARATIVE EXAMPLE 2 using the nickel oxyhydroxide containing only manganese, the discharge performance in the initial stage was deteriorated, and the value of ΔV was increased. In the alkaline primary battery 4 of COMPARATIVE EXAMPLE 3 using the nickel oxyhydroxide containing no manganese nor calcium, the discharge performance both in the initial stage and after storage was insufficient, and the value of ΔV was increased.

### EXAMPLE 2

In the present example, the content of manganese in nickel oxyhydroxide was examined.

Specifically, while the content of calcium was fixed to 2.0×10⁻² mol in a state where the total metallic ion concentration of manganese and calcium was fixed to 2.68 mol/L, the content of manganese was changed to 1.0×10⁻² mol, 2.0×10⁻² mol, 5.0×10⁻² mol, 10.0×10⁻² mol, 12.5×10⁻² mol, or 15.0×10⁻² mol.

Alkaline primary batteries 5 to 10 were produced in the same manner as in EXAMPLE 1, except that at the time of producing nickel hydroxide, a nickel sulfate aqueous solution, a manganese sulfate aqueous solution, and a calcium chloride aqueous solution, each having a predetermined concentration, were used so as to set the contents of manganese and calcium to the above described values. Then, the alkaline primary batteries 5 to 10 were evaluated in the same manner as described above. The results are shown in Table 2 together with the results of alkaline primary batteries 1 and 2 of EXAMPLE 1 and COMPARATIVE EXAMPLE 1.

TABLE 2

| | | | Pulse discharge | | |
|---|---|---|---|---|---|
| | | | | | After two |
| | Content of each | | | | week |
| | element in nickel | | In initial stage | | storage |
| | oxyhydroxide | | Discharge | | Discharge |
| Battery | (×10⁻² mol) | | performance | ΔV value | performance |
| No. | Calcium | Manganese | (index) | (mV) | (index) |
| 2 | 2 | 0 | 123 | 290 | 110 |
| 5 | 2 | 1 | 121 | 288 | 113 |
| 6 | 2 | 2 | 120 | 291 | 120 |
| 1 | 2 | 3 | 121 | 290 | 121 |
| 7 | 2 | 5 | 123 | 288 | 123 |
| 8 | 2 | 10 | 119 | 292 | 119 |
| 9 | 2 | 12.5 | 116 | 298 | 113 |
| 10 | 2 | 15 | 110 | 310 | 100 |

From Table 2, it was found that in the alkaline primary batteries 6 to 8 in which the content of manganese was set in the range from 2.0×10⁻² to 10.0×10⁻² mol per mol of nickel oxyhydroxide, the excellent discharge performance was obtained both in the initial stage and after storage. In the alkaline primary batteries 2 and 5 in which the content of manganese in nickel oxyhydroxide was less than 2.0×10⁻² mol per mol of nickel oxyhydroxide, the discharge performance after storage was insufficient. On the other hand, in the alkaline primary batteries 9 and 10 in which the content of manganese in nickel oxyhydroxide exceeded 10.0×10⁻² mol per mol of nickel oxyhydroxide, the content of nickel was reduced and the discharge performance was deteriorated.

### EXAMPLE 3

In the present example, the content of calcium in nickel oxyhydroxide was examined.

Specifically, while the content of manganese in nickel oxyhydroxide was fixed to 3.0×10⁻² mol per mol of nickel oxyhydroxide in the state where the total metallic ion concentration of manganese and calcium was fixed to 2.68 mol/L, the content of calcium in nickel oxyhydroxide was changed to 0.2×10⁻² mol, 1.0×10⁻² mol, 3.5×10⁻² mol, 5.0×10⁻² mol, 8.0×10⁻² mol, or 10.0×10⁻² mol per mol of nickel oxyhydroxide. Alkaline primary batteries 11 to 16 were produced in the same manner as in EXAMPLE 1, except that at the time of producing nickel hydroxide, a nickel sulfate aqueous solution, a manganese sulfate aqueous solution, and a calcium chloride aqueous solution, each having a predetermined concentration, were used so as to set the contents of manganese and calcium to the above described values. Then, the alkaline primary batteries 11 to 16 were evaluated in the same manner as described above. The results are shown in Table 3 together with the results of alkaline primary batteries 1 and 3 of EXAMPLE 1 and COMPARATIVE EXAMPLE 2.

TABLE 3

| | | | Pulse discharge | | |
|---|---|---|---|---|---|
| | | | | | After two |
| | Content of each | | | | week |
| | element in nickel | | In initial stage | | storage |
| | oxyhydroxide | | Discharge | | Discharge |
| Battery | (×10⁻² mol) | | performance | ΔV value | performance |
| No. | Manganese | Calcium | (index) | (mV) | (index) |
| 3 | 3 | 0 | 95 | 330 | 110 |
| 11 | 3 | 0.2 | 116 | 304 | 116 |
| 12 | 3 | 1 | 118 | 300 | 118 |
| 1 | 3 | 2 | 121 | 290 | 121 |
| 13 | 3 | 3.5 | 123 | 290 | 123 |
| 14 | 3 | 5 | 119 | 295 | 120 |
| 15 | 3 | 8 | 92 | 335 | 105 |
| 16 | 3 | 10 | 86 | 348 | 99 |

From Table 3, it was found that in the alkaline primary batteries 11 to 14 in which the content of calcium was set in the range from 0.2×10⁻² to 5.0×10⁻² mol per mol of nickel oxyhydroxide, the excellent discharge performance was obtained both in the initial stage and after storage.

In the alkaline primary battery 3 in which the content of calcium in nickel oxyhydroxide was less than 0.2×10⁻² mol per mol of nickel oxyhydroxide, the discharge performance both in the initial stage and after storage was deteriorated. On the other hand, in the alkaline primary batteries 15 and 16 in which the content of calcium in nickel oxyhydroxide exceeded 5.0×10⁻² mol per mol of nickel oxyhydroxide, the content of nickel was reduced and the discharge performance was deteriorated.

The alkaline primary battery according to the present invention is excellent in the heavy load pulse discharge performance and the storage performance, and hence is suitably used as a power source of a digital apparatus represented by a digital camera.

Although the present invention has been described in terms of the presently preferred embodiments, it is to be understood that such disclosure is not to be interpreted as limiting. Various alterations and modifications will no doubt become apparent to those skilled in the art to which the present invention pertains, after having read the above disclosure. Accordingly, it is intended that the appended claims be interpreted as covering all alterations and modifications as fall within the true spirit and scope of the invention.

1. An alkaline primary battery including: a positive electrode containing at least nickel oxyhydroxide as a positive electrode active material; a negative electrode containing zinc or a zinc alloy as a negative electrode active material; a separator arranged between said positive electrode and said negative electrode; and an alkaline electrolyte,
characterized in that said nickel oxyhydroxide contains at least manganese and calcium as elements forming solid solution or eutectic crystal with the nickel oxyhydroxide.

2. The alkaline primary battery according to claim 1, wherein said nickel oxyhydroxide contains manganese in an amount of 2.0×10⁻² to 10.0×10⁻² mol per mol of nickel oxyhydroxide, and calcium in an amount of 0.2×10⁻² to 5.0×10⁻² mol per mol of nickel oxyhydroxide.

3. The alkaline primary battery according to claim 1, wherein said nickel oxyhydroxide contains manganese in an amount of 2.0×10⁻² to 5.0×10⁻² mol per mol of nickel oxyhydroxide, and calcium in an amount of 2.0×10⁻² to 5.0×10⁻² mol per mol of nickel oxyhydroxide.
